(19) United States
(12) Patent Application Publication
(10) Pub. No.: US 2004/0243262 A1
(43) Pub. Date: Dec. 2, 2004

(54) System and method for golf course management

(76) Inventor: James H. Hofmann, Escondido, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/855,123

(22) Filed: May 27, 2004

Related U.S. Application Data
(60) Provisional application No. 60/472,866, filed on May 27, 2003.

(51) Int. Cl. G06F 155/00; A63B 43/00

(52) U.S. Cl. 700/91

(57) ABSTRACT

The present invention provides a system and method for real time golf course management. The system comprises a plurality of stationary wireless transceivers strategically located around a golf course. A plurality of mobile wireless transceiver are each integrated with a golf cart and configured to transmit a unique identifier for the golf cart to one of the stationary wireless transceivers in proximity to the golf cart. Accordingly, as a golf cart passes a stationary wireless transceiver, the stationary wireless transceiver receives the unique identifier being transmitted by the golf cart and sends the identifier over a wireless network to a central server located in the club house. The central server records the time that the golf cart passed the stationary wireless transceiver. Cumulatively, the central server is able to passively track pace of play statistics for the golf course and identify bottlenecks that may adversely affect player throughput.

### RELATED APPLICATION

The present application claims priority to U.S. provisional patent application Ser. No. 60/472,866 entitled REAL TIME GOLF COURSE MANAGEMENT SYSTEM filed on May 27, 2003, which is incorporated herein by reference in its entirety.

### BACKGROUND

1. Field of the Invention

The present invention generally relates to golf course management and more particularly relates to real time management of the pace of play on a golf course and maximizing player density and throughput on a golf course.

2. Related Art

Conventional tee time software utilities and pro shop sales utilities are abundant at golf courses today. Unfortunately, these conventional systems are typically not integrated and require employees to learn and operate different programs. Additionally, often times the starter is not provided with up to date information regarding the status of tee times and therefore much time is wasted on telephone or messenger communications between the pro shop and the starter in order to keep in synch.

Furthermore, slow play on a golf course can significantly diminish a player's enjoyment of the game and adversely influence the player's decision to return to the particular course for subsequent rounds. Additionally, slow play decreases the throughput of players on a course, which in turn drives down profits for the golf course.

Recently, global positioning system (“GPS”) systems have been introduced to provide players with information about the course and the particular hole being played. These systems may also include food ordering capabilities that allow players to order food from the course and pick up the order when passing by the clubhouse, for example between the 9^{th} and 10^{th} holes. These systems, however, are prohibitively expensive to install and have ongoing monthly maintenance and communication fees that must be paid by the golf course. Additionally, the expensive GPS systems are unable to identify slow players or “traffic jams” on the course. Some GPS systems do provide a rudimentary elapsed time feature, but those systems are limited to a simple running timer that starts when a group begins the round and ends when the group finishes the round.

Accordingly, what is needed is a cost effective system and method that synchronizes communications related to golf course management and facilitates increasing the pace of play on a golf course to maximize player density and player throughput.

### SUMMARY

A system and method for real time golf course management is provided. The system comprises a golf course with a plurality of stationary wireless transceivers strategically placed around the course, preferably located at or near each tee box. Additionally, the system includes a plurality of golf carts, each outfitted with a unique identifier and a mobile wireless transceiver configured to transmit the identifier to a stationary wireless transceiver. As a golf cart passes a stationary wireless transceiver, the stationary wireless transceiver receives the unique identifier being transmitted by the golf cart and sends the identifier over a wireless network to a central server located in the club house. The central server records the time that the golf cart passed the stationary wireless transceiver and thereby maintains pace of play statistics for the golf course.

Additional implementations and advantages of the invention will be apparent to those having skill in the art upon review of the following detailed description and figures.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a block diagram illustrating an example stationary transceiver according to an embodiment of the present invention;

FIG. 1B is a block diagram illustrating an example golf course hole according to an embodiment of the present invention;

FIG. 1C is a block diagram illustrating an example layout for stationary transceivers on a golf course according to an embodiment of the present invention;

FIG. 2 is a block diagram illustrating an example golf cart coupled with an example mobile transceiver according to an embodiment of the present invention;

FIG. 3 is a network diagram illustrating an example data communication network according to an embodiment of the present invention;

FIGS. 4-14 are example screen shots of a golf course management system according to an embodiment of the present invention;

FIG. 15 is a block diagram illustrating an exemplary wireless communication device that may be used in connection with the various embodiments described herein; and

FIG. 16 is a block diagram illustrating an exemplary computer system as may be used in connection with various embodiments described herein.

### DETAILED DESCRIPTION

Certain embodiments as disclosed herein provide for systems and methods for real time golf course management. For example, one method as disclosed herein allows for golf carts equipped with wireless radio frequency identifiers to pass by a plurality of receiving stations during a round of play. When a golf cart passes by the receiving station, the station reads the identification for the cart and transmits the cart ID and its own station ID to a central server. The central server receives and timestamps the transmission and then stores the location of the cart at the particular time. The server accordingly tracks in real time the location of golf carts and associated players on the golf course.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

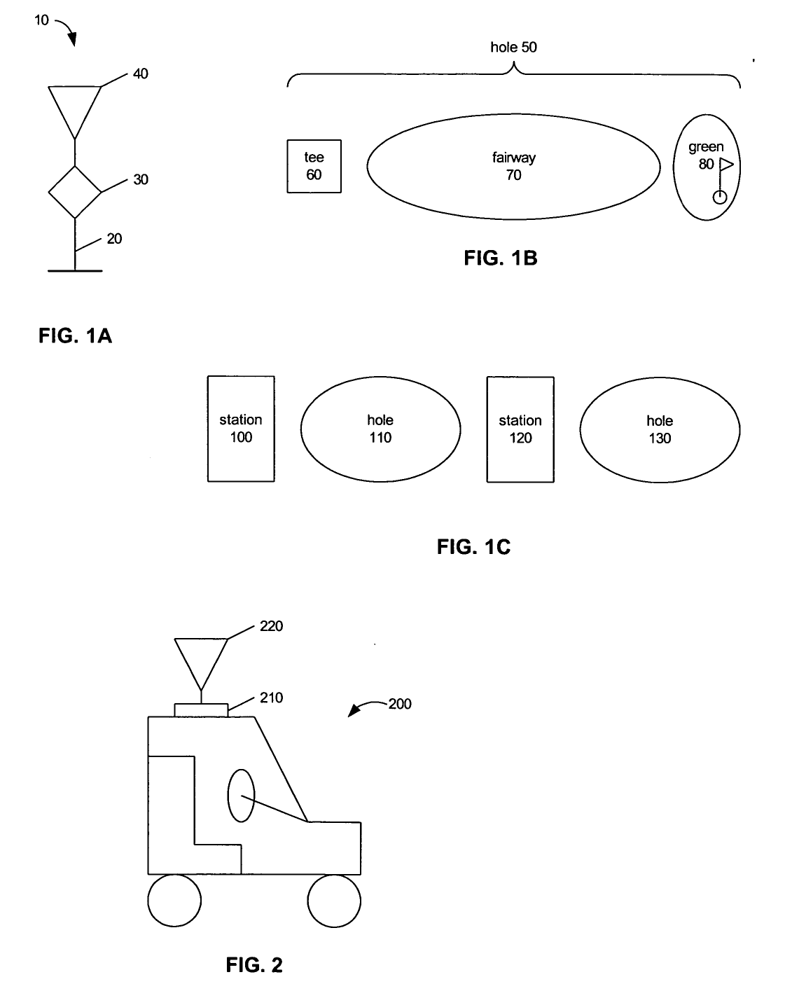

FIG. 1A is a block diagram illustrating an example stationary transceiver 10 according to an embodiment of the present invention. In the illustrated embodiment, the transceiver 10 is mounted on a pole 20 and includes a solar-electric panel 30 and an antenna 40. Preferably, the solar-electric panel 30 generates all of the electricity needed by the station 10 in order to operate. The station 10 may also have a battery backup system (not shown).

Antenna/reader 40 is configured to send and receive wireless communications. For example, antenna/reader 40 is preferably configured to directly receive radio frequency identification (“RFID”) messages transmitted by a golf cart within a certain proximity to the station 10. In one embodiment, the station 10 can receive a direct RFID transmission from a cart within 30 feet of the station 10. Additionally, antenna/reader 40 is configured to send and receive data communications over a wireless communication network.

FIG. 1B is a block diagram illustrating an example golf course hole 50 according to an embodiment of the present invention. In the illustrated embodiment, the hole 50 comprises a tee box 60, a fairway 70, and a green 80. Although conventional golf course holes such as hole 50 may have additional features such as a sand trap, hole 50 is illustrated to show from left to right the conventional layout. The layout provides a certain geographical relationship between the various holes of a golf course, namely that the tee box 60 precedes the green 80 during normal play. Additionally, as the holes of a golf course are played one after the other, the next tee box (not shown) is visited by a player after completing play on the green 80.

In accordance with the layout of the example golf course hole in FIG. 1B, the placement of a plurality of stationary transceivers on a golf course is presented in FIG. 1C according to an embodiment of the present invention. In the illustrated embodiment, a station 100 is placed before the hole 110 and the station 120 is placed after the hole 110 and before the hole 130.

In one embodiment, there are 19 stations placed strategically around an 18 hole golf course. For example, a first station (such as station 100) can be placed just beyond the tee box for the first hole. When the players finish teeing off on the first hole, they pass the station on their way to the fairway and ultimately the next hole. Subsequent stations may be place just before the tee box of each following hole so that when the station reads the RFIDs for the golf carts, the players in the carts have completed the previous hole and are close to beginning the next hole. Finally, at the end of the 18^{th} hole, the final (i.e., nineteenth) transceiver station can be located such that it receives the RFIDs for the golf carts after the players have finished the entire round.

In an alternative embodiment, the first station can be placed at the tee box for the first hole. In such an embodiment, the station may continuously read the presence of the golf carts. When a lack of presence is subsequently detected, the station may then record (or transmit as the case may be) that the players have begun the hole. Various alternative techniques may also be employed around a tee box to differentiate between golf carts belonging to more than one group, for example, when the course is delayed and players have to wait in line at the tee box for a particular hole. In one such embodiment, the time of the end of the previous hole may be identified and then coupled with the time that the players in front of the subject group of players left the tee box in order to calculate the wait time for the subject group at the particular hole. Additional refinements may also be made throughout the course to more accurately track the playing time and wait time for individual players and groups. Advantageously, if a particular group with a history of playing well and quickly has to wait more than a certain threshold during their round, that group may be targeted to receive a discount coupon for pro shop merchandise or a discount coupon for their next round of golf.

In summary of FIGS. 1A, 1B, and 1C, various transceiver stations are strategically located throughout the golf course so that they can accurately track the passing of golf carts equipped with RFID emitters (or other wireless identification systems) and report the respective passing time to a central server via a wireless communication network.

FIG. 2 is a block diagram illustrating an example golf cart 200 coupled with an example mobile transceiver 220 according to an embodiment of the present invention. In the illustrated embodiment, the golf cart 200 is configured with an RFID tag 210 that contains a unique identifier for the particular golf cart 200. The unique RFID tag 210 is preferably coupled with the transceiver 220 so that the golf cart 200 can broadcast its unique identifier as it travels around the course. In one embodiment, an RFID tag can be roughly the size of a playing card and affixed to the roof or other surface of the golf cart

Advantageously, because the golf cart 200 has a battery power system, the transceiver 220 may be electrically connected to that power system so that it may continuously broadcast the unique identifier. Continuous broadcasting of the unique identifier is preferred when an abundant power source is available. In an alternative embodiment, the transceiver 220 may periodically broadcast in order to preserve battery life. The transceiver 220 may also be solar powered.

In one embodiment, the transceiver 220 may be configured to receive video that is transmitted to the golf cart. For example, the transmitter may be coupled with a video monitor located in the cart so that any video transmissions received by the transceiver 220 can be displayed on the video monitor.

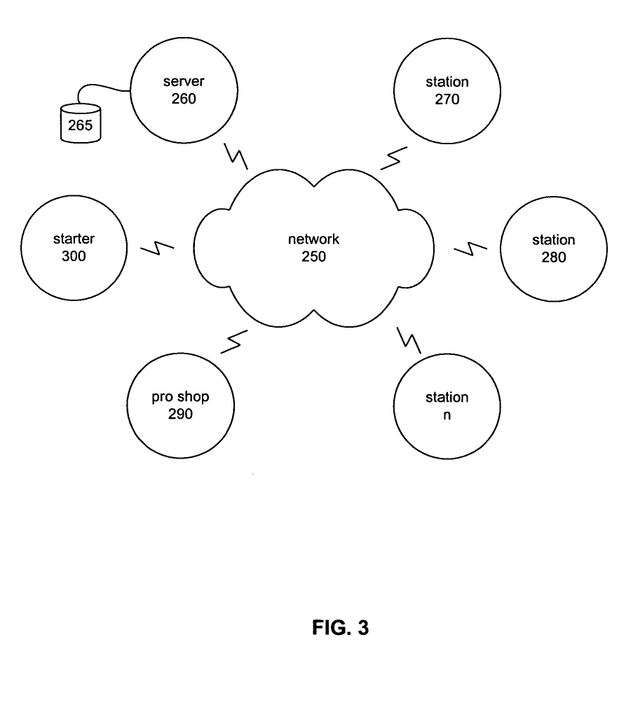

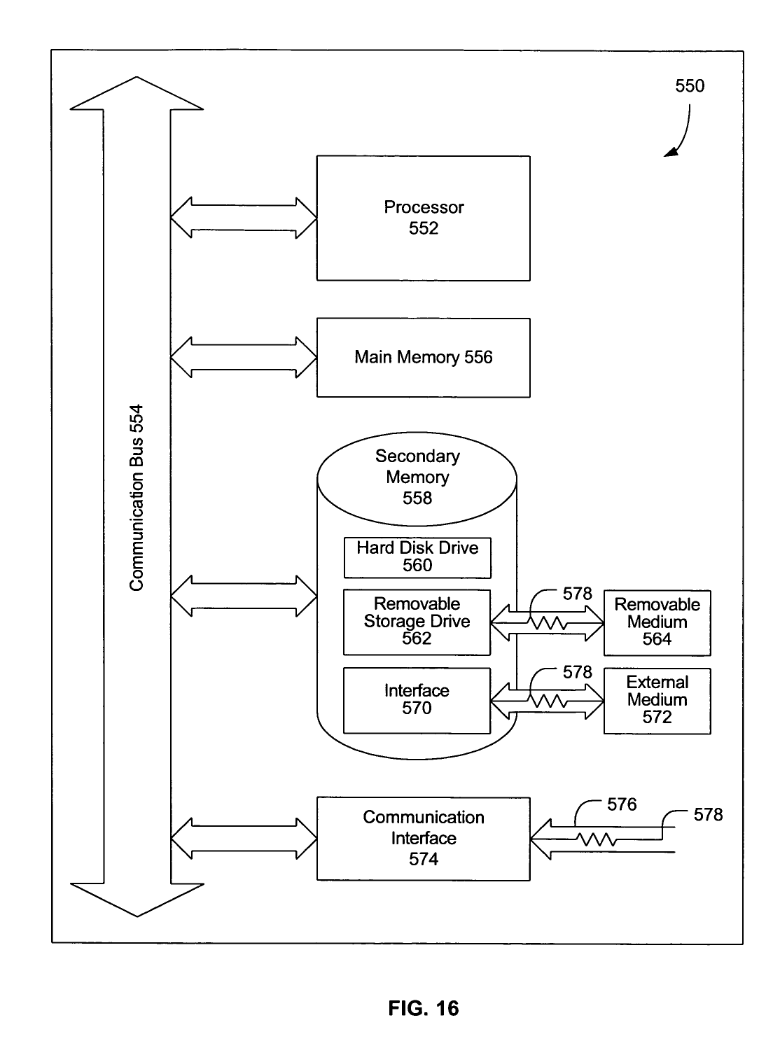

FIG. 3 is a network diagram illustrating an example data communication network 250 according to an embodiment of the present invention. In the illustrated embodiment, the network 250 communicatively couples a central server 260, which is configured with a data storage area 265, and a plurality of transceiver stations 270, 280, and n. Also connected to the network 250 are the pro shop 290 and the starter 300. Because a golf course may have 9, 18, 36, or more holes, the number of transceiver stations may vary per course. Accordingly, there is no set number of stations that can be connected to the network 250. In one embodiment, the network 250 is a wireless communication network. In such an embodiment, a transceiver (not shown) is coupled with the central server 260, which is preferably a general purpose computer such as the one later described with respect to FIG. 16.

In an alternative embodiment, the network can be a wired network, although such an implementation would be impractical. Even in the case where the wired network 250 was installed during construction of the course so that the networking cable could be placed underground without disrupting the course, a wireless network 250 is still preferred due to the flexibility it provides and the subsequent ability to alter the course. For example, it is not uncommon for a golf course to change the location of tee boxes.

In operation, the wireless network 250 carries data communications between the various transceiver stations and the central server 260. The central server 260 is configured to receive communications from the transceiver stations and store information related to the time that a particular golf cart passed a particular transceiver station. Accordingly the server 260 is able to compile a present status of what player groups are on what holes and thereby determine if the golf course is experiencing delay or backup. Advantageously, if a delay is detected by the server 260, it is configured to issue an alarm or otherwise notify an official so that a marshal or other course employee can be dispatched to the location of the backup and resolve the situation.

A significant benefit of the notification ability of the server 260 is that course delays can be managed and kept to a minimum. The minimization of course delays results in a higher throughput of player groups and increased profits for the course. Additionally, the players have a more enjoyable experience and are more likely to return to the course for another round. Another significant benefit of tracking players and the pace of play around the course is that new groups of players can be inserted at any hole on the course where there is enough lag between groups.

In one embodiment, the central server 260 may also perform a forecasting function to determine if the inserted group will have a gap when they make the turn (i.e., go from the 9^{th} green to the 10^{th} tee box). The server 260 can also slightly adjust the tee times for groups that are scheduled later in order to create a gap for the inserted group. Thus, the server 260 can, in real time, increase the density of players on the course in order to maximize revenue by maximizing the number of rounds played in a given day.

In one embodiment, the central server 260 may be connected to the pro shop via the network 250. Alternatively, the pro shop may have a remote monitor or remote access station in the pro shop that can access the server 260 but not the network 250. Accordingly, when new players arrive in the pro shop and pay for their round of golf, information about the players can be collected at the point of the transaction. Advantageously, a record for the players/group is then stored in the server 260 and the subsequent information related to the players/group is associated with that record in the server 260.

Additionally, the starter is also preferably connected to the server via the network 250 or through a direct connection, for example a remote monitor or a remote access station. Thus, any changes made to the scheduled tee times by the pro shop or the server 260 are immediately propagated to the starter in real time so that the newly calculated tee times can be implemented.

In one embodiment, a remote terminal or workstation (not shown) can be located in the cart garage so that a manager can maintain an accurate list of available golf carts that can be assigned to groups of players by the server 260. An additional advantage is that the cart garage can bring the appropriate cart up to the pro shop so that when the players exit the pro shop their cart will be waiting for them.

In another embodiment, the server 260 can be communicatively coupled to an external network such as the internet (not shown) or an internal wide area network (not shown). Such a connection preferably allows remote access to the server 260 so that individuals that are off premises may access information about course activity. For example, golf management companies can observe pace of play information for a plurality of golf courses that are geographically located in many different areas of the city, county, state, country, or world.

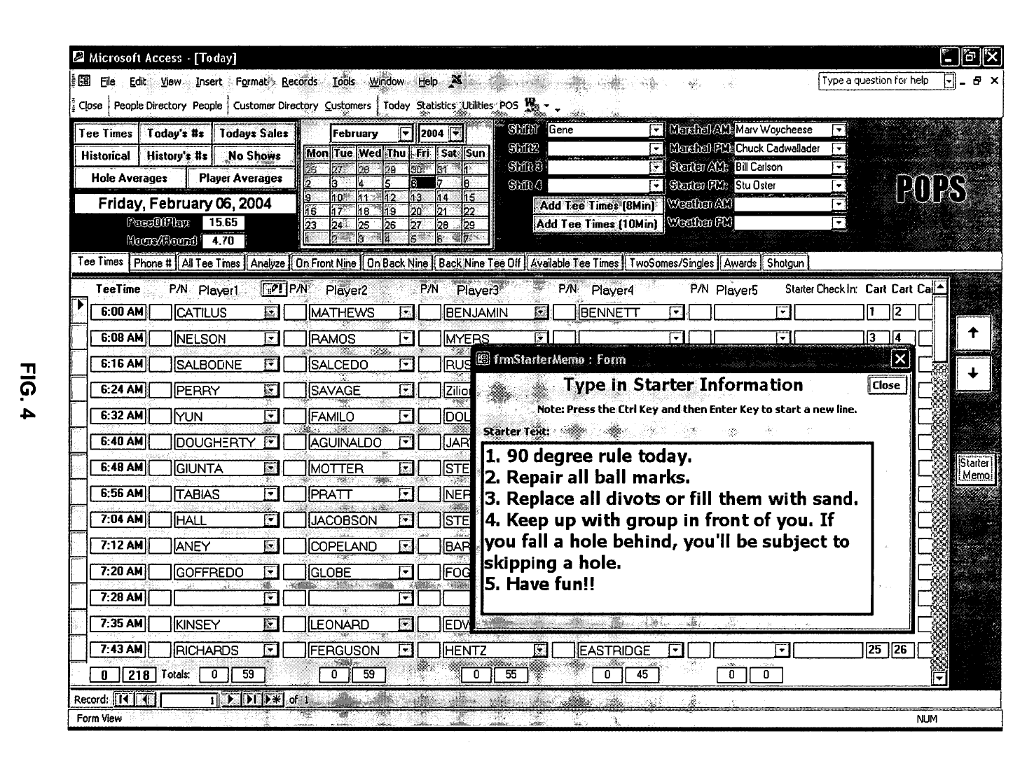

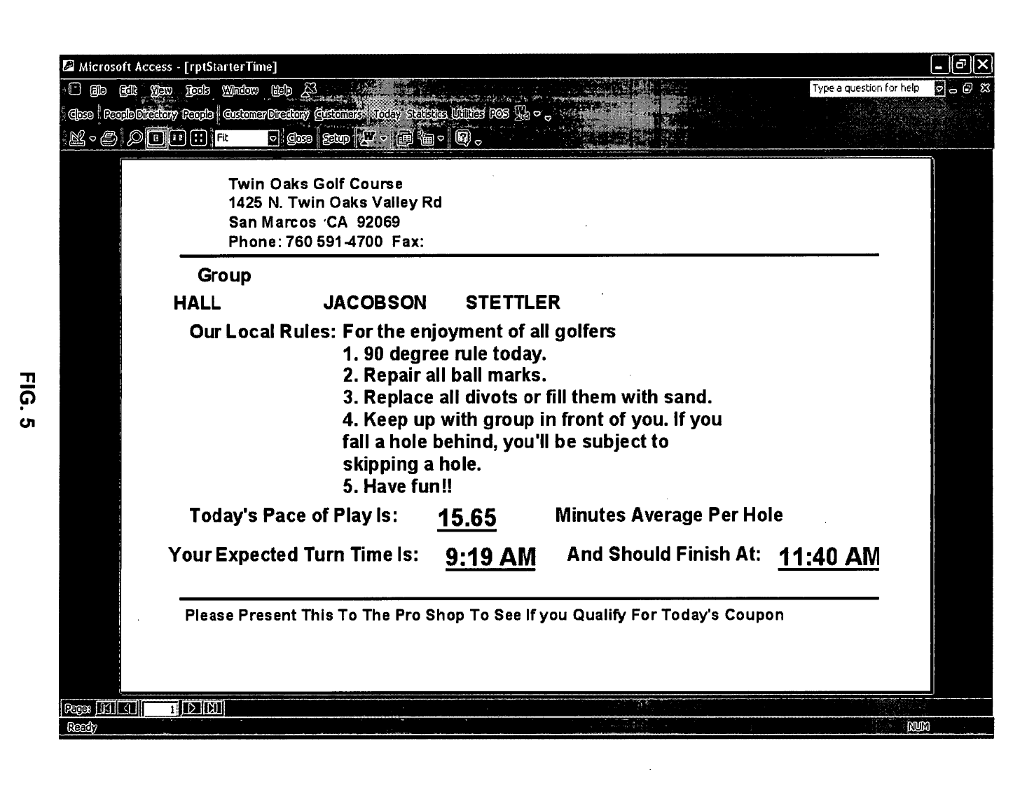

FIGS. 4-14 are example screen shots of a golf course management system according to an embodiment of the present invention. FIG. 4 shows a screen that may be seen by the starter. The starter can double click in the box labeled “Starter Check In:” in order to initiate a group of players. In one embodiment, a local printer may print out a list of rules that govern play for the current conditions on the course. Additional items such as coupons may also be printed out and give to the players. For example, FIG. 5 shows a printout with the list of rules, the pace of play, the expected turn time, the expected finish time, and a message at the bottom to encourage the players to visit the pro shop at the end of their round to see if they qualify for a coupon (free drink, discount on merchandise or a later round of golf, etc.).

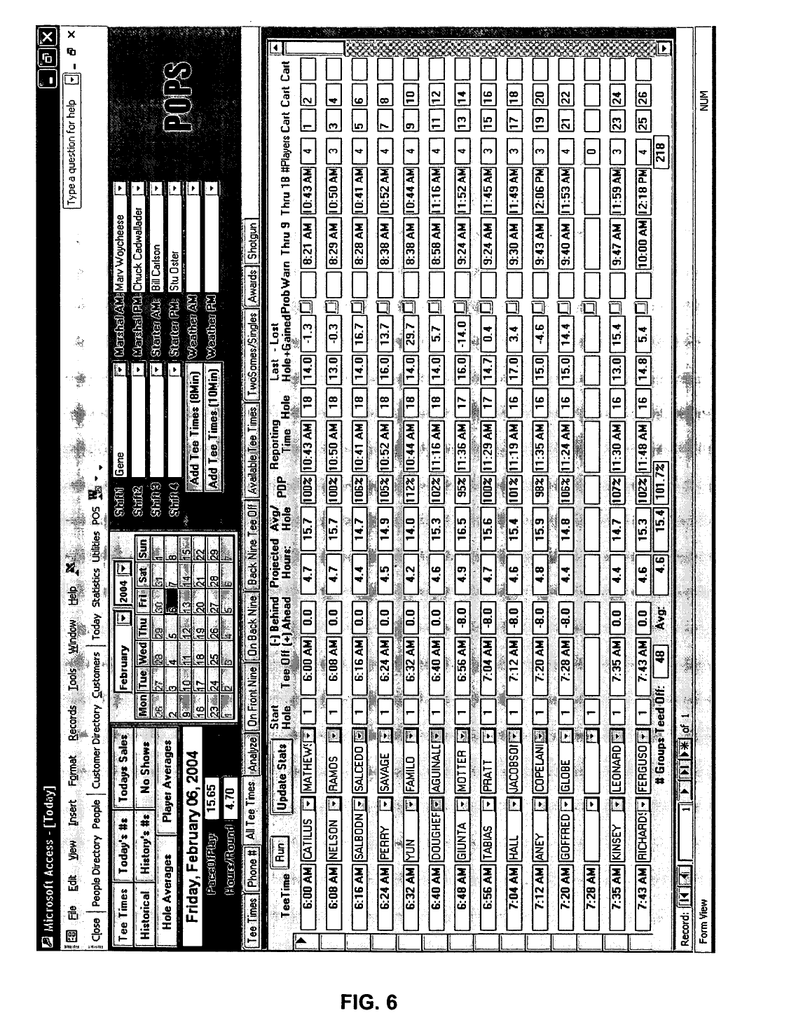

FIG. 6 is a screen shot showing the real time status of a golf course. The pace of play is listed in the header information of the screen and then the body of the status screen shows the data that has been collected by the transceiver stations located throughout the golf course. This data is populated into the fields by the server and projections are calculated and updated in real time to forecast when groups will finish, whether they are on time or expected to finish on time, etc. For example, the time it took to play the most recent hole is displayed. So is the total minutes that a particular group is ahead or behind the pace of play. Additionally, the average time per hole and per round is also calculated and displayed. Advantageously, this information can be available to the pro shop, the starter, and also a telephone operator so that groups tee off on time, new walk up groups can be efficiently received, and groups calling in may be informed of the wait or given an accurate tee time.

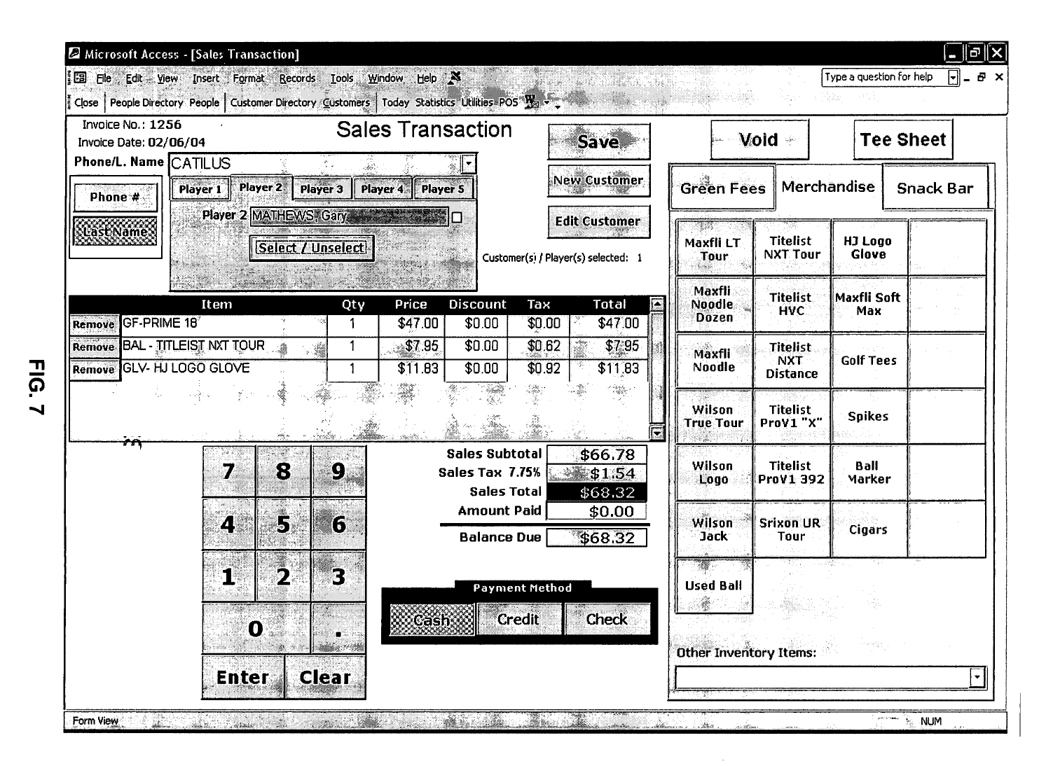

FIG. 7 is a screen shot showing an example point of sale screen that can be used by the pro shop to collect information about a group of players. Advantageously, this information can be tracked over time so that the golf course can maintain historical information about which golfers are frequent players. Additionally, the golf course can also identify which golfers are slow players and fast players. Such historical information may advantageously allow the server to place certain players (e.g., fast players) in the morning rounds so that the pace of play is not adversely affected early in the day. Such a strategy can advantageously increase player throughput and golf course profit.

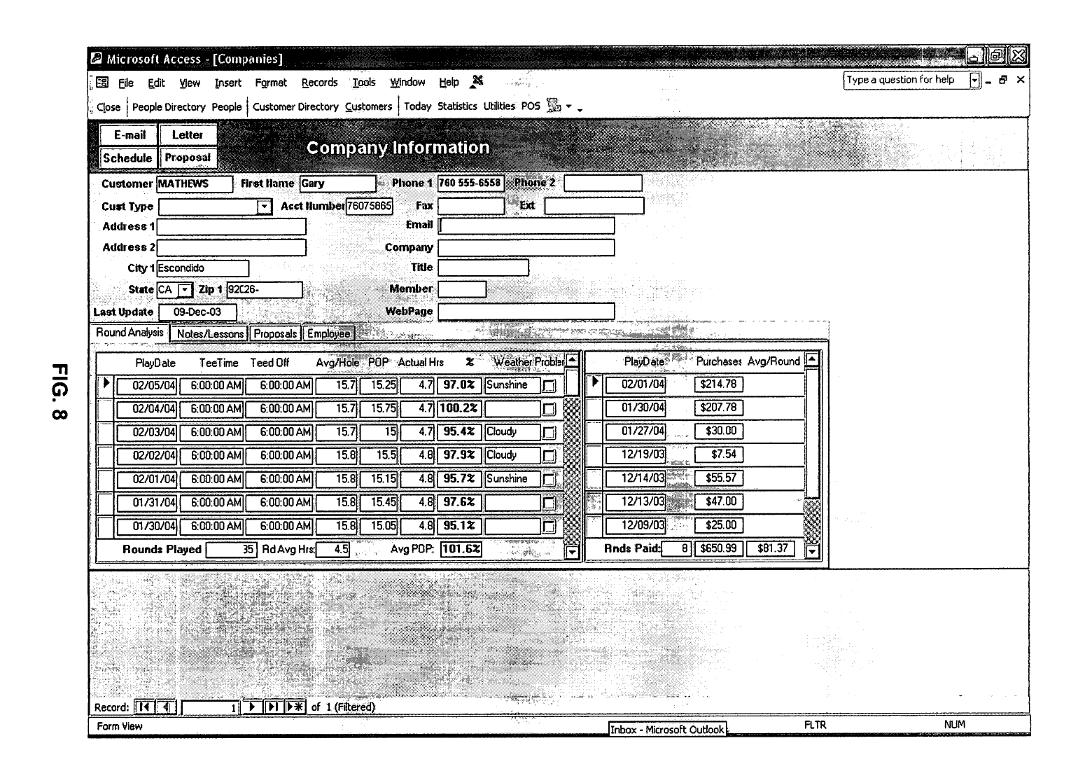

Other advantages of tracking historical information will also be apparent to those having skill in the art. For example, frequent players may receive a free round after 10 rounds or receive a discount coupon for merchandise. A significant benefit of tracking historical information is also the ability for the golf course to be proactive in scheduling tee times. For example, if a particular fast player has not played in a while and an opening is available for a fast player at a desirable tee time, the golf course may call or otherwise contact the player to see if he or she would like to reserve the open tee time. Such a strategy would advantageously both increase goodwill with the particular player, but also increase the density of players on the course and maximize profits. Accordingly, collection and retention of email addresses for individual players may provide a significant marketing benefit, allowing a golf course to automatically select a desired group of players to fill available tee times. FIG. 8 shows an example screen with individual player statistics and historical information.

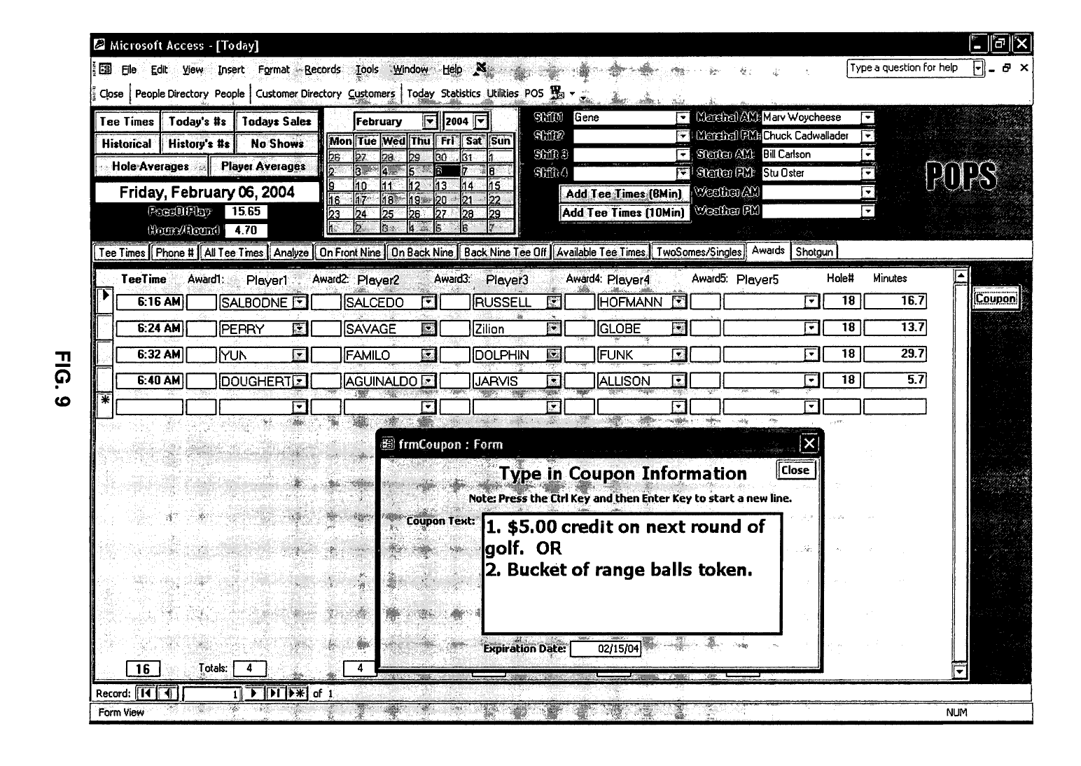

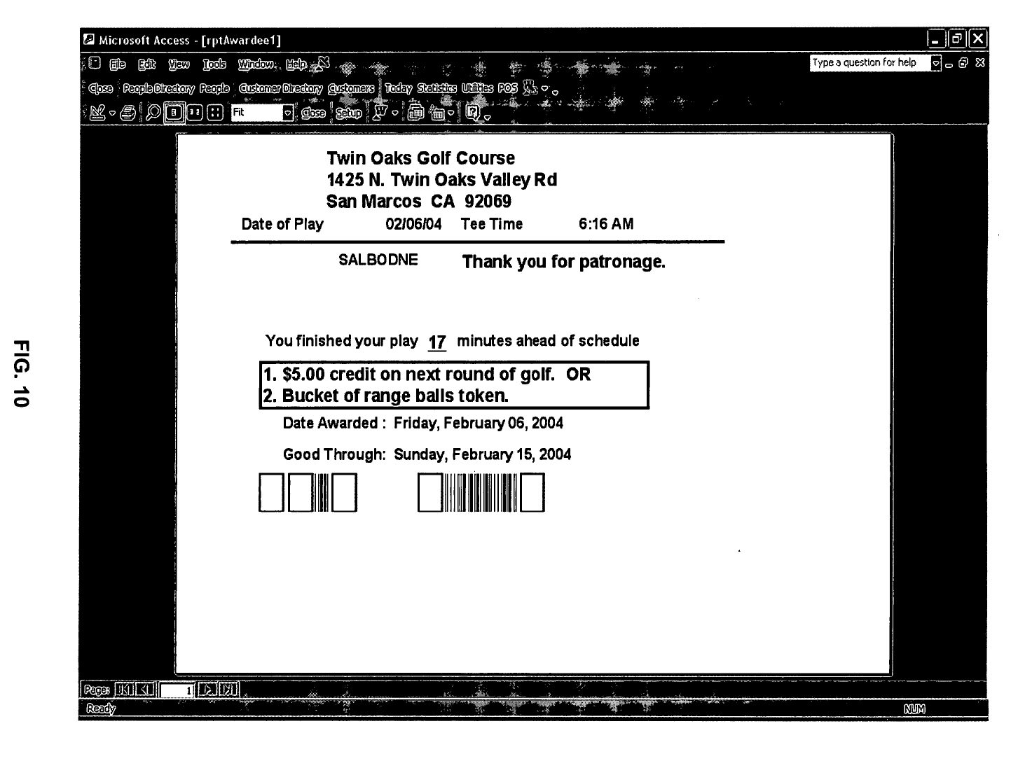

FIG. 9 is an example screen shot of a coupon that can be created within the server. Accordingly, when a player returns to the pro shop after a round and has, for example, finished play at a pace faster than the scheduled pace for the day, the player may be rewarded with a coupon for a discount on the player's next round of golf or a free token for a bucket of range balls, for example. Additionally, the player's visit to the pro shop may also result in a purchase of some other item in the pro shop, thus increasing profits for the golf course. FIG. 10 is an example screen shot of the coupon that is printed out and given to the player. In one embodiment, the coupon can be bar coded in order to record the transaction and later associate the use of the coupon with the issuance of the coupon.

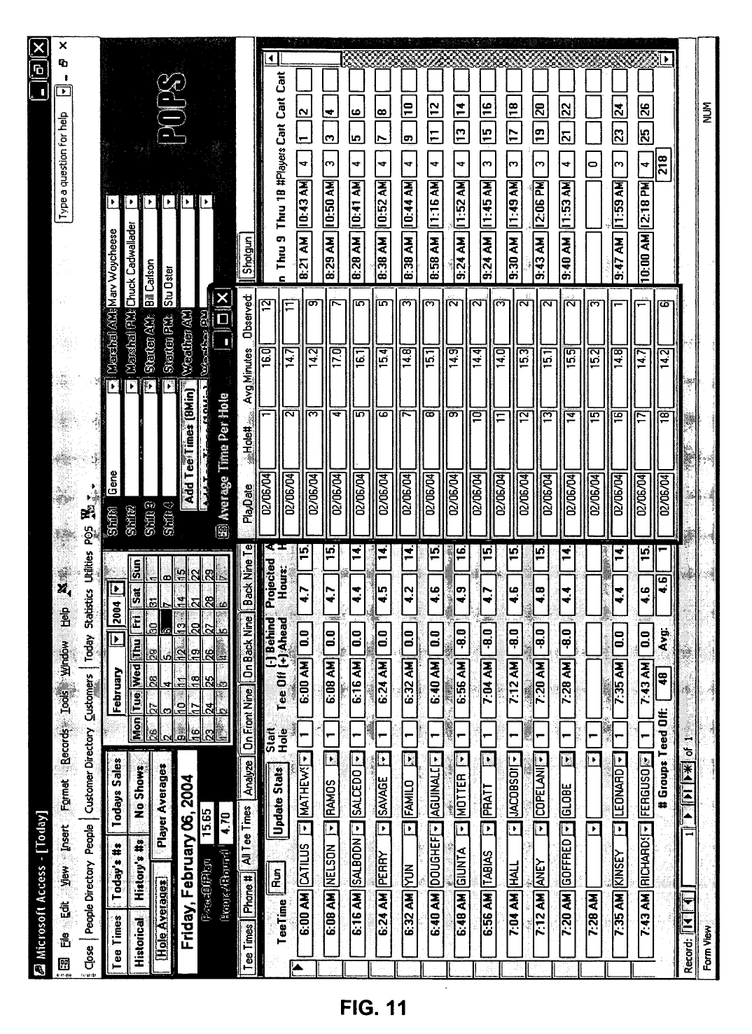

FIG. 11 is a screen shot showing an example dialog window having the average times per hole. Advantageously, this information can be collected and tracked over time by the server so that the golf course management may review the information to determine if a particular hole needs to be redesigned in order to increase throughput. For example, a particular sand trap may be located such that it receives a large number of shots and thereby results in a significant delay for each group due to the additional shots required for players to get out of the sand trap and finish the hole. In such a case, the management may remove the sand trap in favor of a water hazard so that the difficulty of the course remains the same, but the pace of play is not too severely impacted.

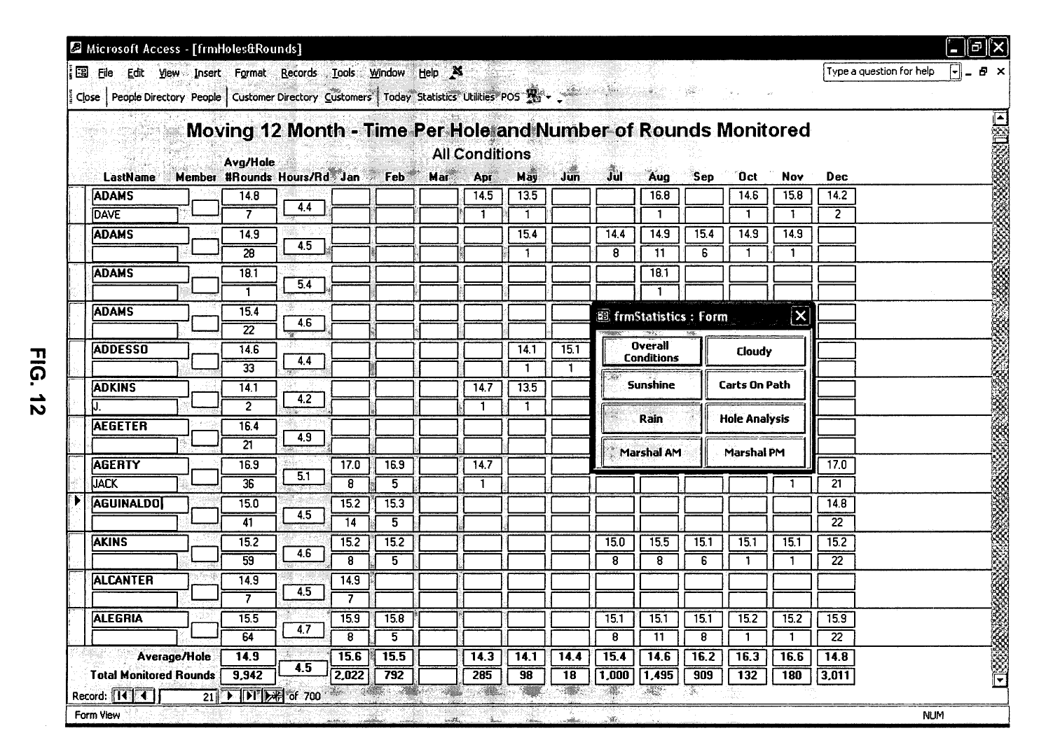

FIG. 12 is a screen shot showing an example statistical analysis for each player over a particular time period, in this case, 12 months. Such information can be tracked for the player and associated with the particular conditions for the days that the player was on the golf course. This information may lead the golf course, for example, to contact players that are fast in bad conditions and offer them morning tee times when it is anticipated that the course conditions will improve during the day.

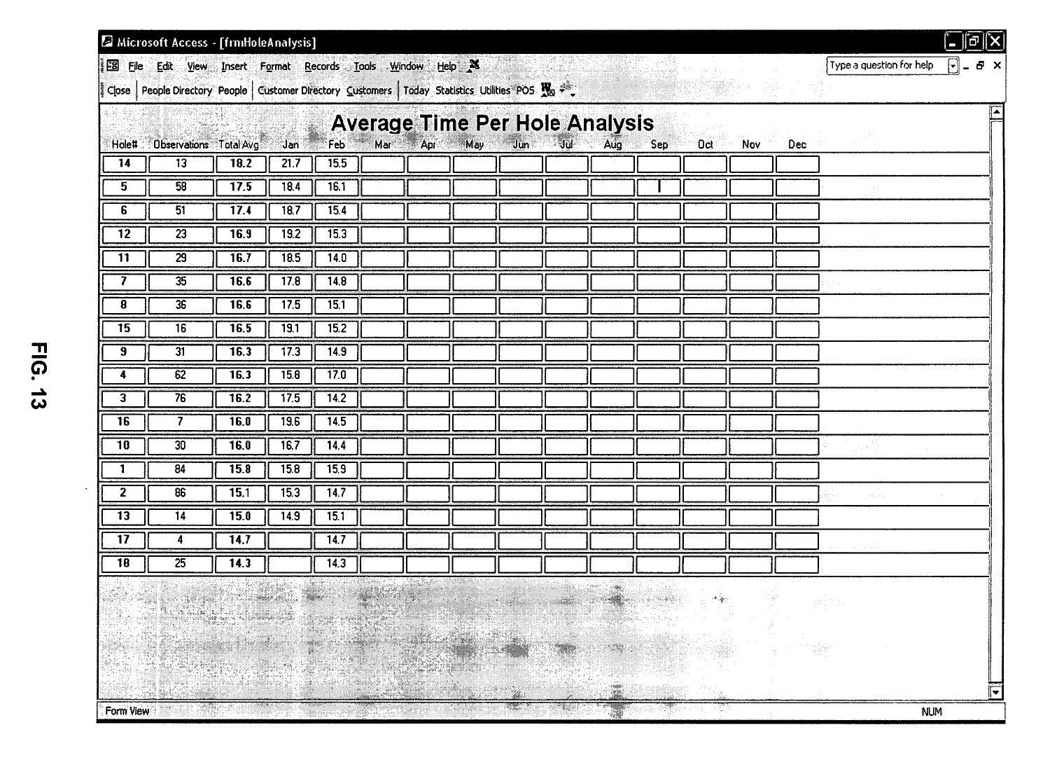

FIG. 13 is a screen shot illustrating the average time per hole analysis as discussed briefly above with respect to FIG. 11. While FIG. 11 shows the average time for a particular day, FIG. 13 shows the average time over several months. As previously described, such information may be extremely valuable to the golf course when making decisions about how to remodel the course in order to increase player throughput.

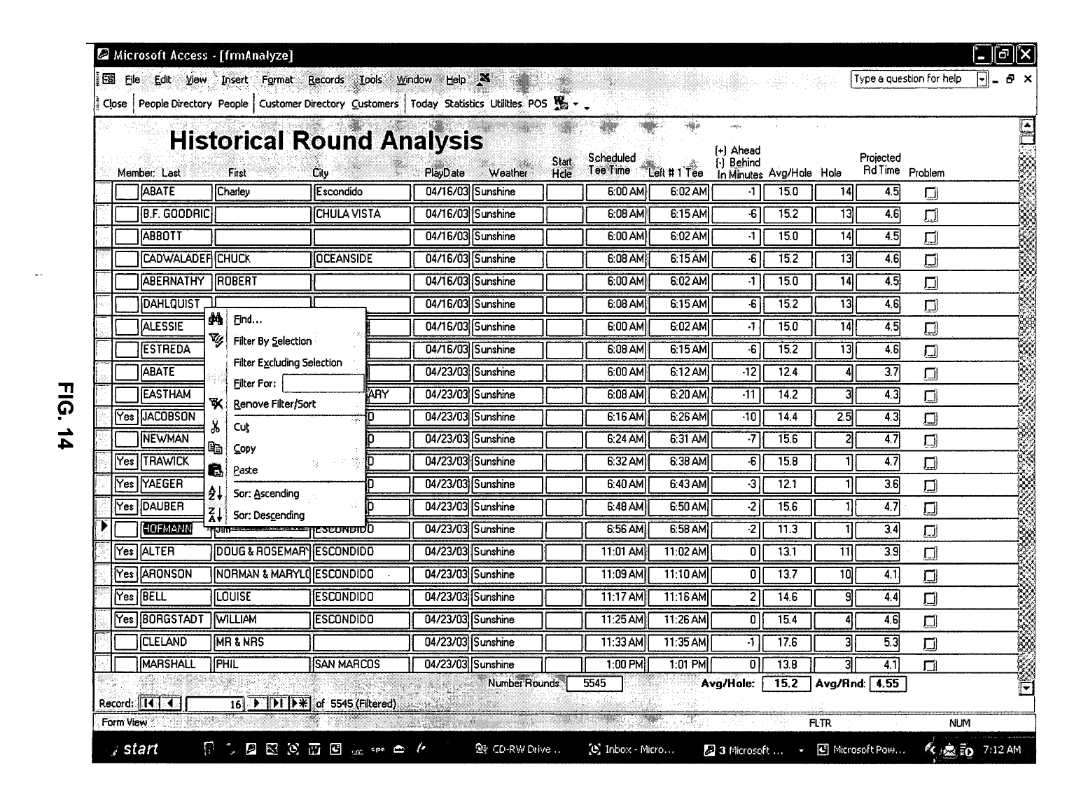

FIG. 14 is a screen shot showing an example analysis utility that is available on the server. Advantageously, the illustrated pop-up menu allows the pro shop or starter or other golf course personnel to filter information contained in the database that is maintained by the server.

In summary of FIGS. 4-14, many key personnel at a golf course are preferably given access to the server system so that they may participate in optimizing the number of players that are on the course at a given time and the number of players that play on a given day. The server provides informational screens that allow course managers to see in real time where possible bottlenecks are on the course so that corrective action can be taken to minimize any adverse effect on player throughput. The server receives information from the various transceiver stations located throughout the golf course and provide that information through the various screens. The information is also collected in a data storage area so that historical analysis may be performed.

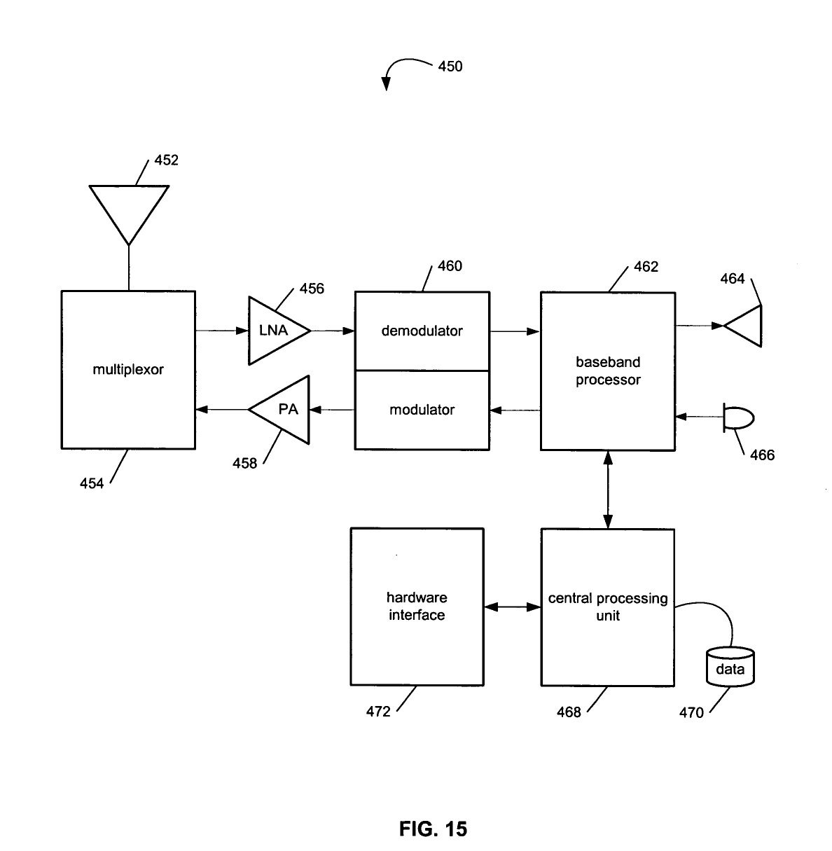

FIG. 15 is a block diagram illustrating an exemplary wireless communication device 450 that may be used in connection with the various embodiments described herein. For example, the wireless communication device 450 may be employed as a mobile transceiver station on a golf cart, a stationary transceiver station located on the course, or as the central transceiver station located at or near the pro shop. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

FIG. 16 is a block diagram illustrating an exemplary computer system 550 that may be used in connection with the various embodiments described herein. For example, the computer system 550 may be used in conjunction with the pro shop server computer. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

While the particular systems and methods herein shown and described in detail are fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A system for golf course management, comprising:
a wireless communication network;
a plurality of transceiver stations coupled to the wireless communication network, each transceiver station having a unique transceiver identifier and configured to wirelessly receive a unique cart identification from a golf cart in proximity to the station;
a server computer coupled to the plurality of transceiver stations via the wireless communication network, the server configured to receive and timestamp a communication from a transceiver station, the communication including the unique transceiver identifier and the unique cart identifier;
wherein the server computer stores the timestamp information in a data storage area and associates the timestamp information with a group of players in order to track the pace of play on the golf course.

2. A method for golf course management, comprising:
receiving via a wireless communication at a transceiver station having a unique transceiver identifier a unique cart identifier from a golf cart in proximity to the transceiver station;
transmitting the unique transceiver identification and the unique cart identifier to a server computer;
applying a timestamp to the transmission at the server computer;
storing the timestamp in a data storage area at the server computer;
associating the timestamp with a group of players at the server computer; and
tracking the pace of play on the golf course for the group of players.
